(19) United States
(12) Patent Application Publication
(10) Pub. No.: US 2009/0139122 A1
(43) Pub. Date: Jun. 4, 2009

(54) Variable matrix display device and method

(75) Inventors: Didier Le Gall, Draveil (FR); Yannick Le Gall, Draveil (FR); Marc Hermelin, Combs La Ville (FR); Andre Testa, Boissy Saint Leger (FR); Philippe Planard, Bures Sur Yvette (FR)

Correspondence Address: YOUNG & THOMPSON, 209 Madison Street, Suite 500, ALEXANDRIA, VA, 22314, US

(73) Assignee: BIG WALL VISION (S.A.R.L. ), Paris (FR)

(21) Appl. No.: 11/667,359

(22) PCT Filed: Sep. 10, 2004
(86) PCT No.: PCT/FR2004/002311

§ 371 Date: May 9, 2007

(51) Int. Cl. G09F 11/18

(52) U.S. Cl. 40/518

(57) ABSTRACT

A device (1) for displaying an aggregate image (2) the form of a matrix. Each cell (4) of the matrix (3) enables display of an elementary image (6). The elementary images are carried out on a ribbon (7). In order to vary the aggregate image, the elementary image is varied, the former being selected on the ribbon by causing the ribbon to run off inside the cell. The device enables the creation of very large display panels, particularly those used at airports.

This invention relates to a matrix display method for a display panel, and a device implementing such a method.

Variable display panels exist which have large dimensions, in particular used in airports and stations for displaying arrivals and departures. However, these panels are only suitable for displaying images essentially composed of alphanumeric characters.

Other variable display panels, mainly of an advertising type, make it possible to display images, generally of an illustration type, i.e. for example originating from a photograph or drawing.

These other panels comprise two types. In a first type, several images are arranged so that they form a band unrolling and rolling up respectively on two rollers, so that they are displayed successively. In a second type, three images are distributed on three faces of several revolving columns with a triangular horizontal section, so that each time that the column carried out a third of a turn about a vertical axis respectively, a different image from the three is displayed.

However, these other panels cannot be adapted to a display with large dimensions, the technical problems and costs which would result are not suitable for normal use. They are therefore limited to reduced sizes of image, and generally used for the display of advertising images of four metres by three metres.

The purpose of the invention is propose a display method and a device making it possible to display, at a reasonable cost, images with large dimensions of whatever type, alphanumeric or illustrative.

According to the invention, such a display method for forming an aggregate image comprises the following stages:

breaking down the aggregate image into several elementary images of this aggregate image, each corresponding to a cell of a matrix of the display device;

forming series of elementary images on as many ribbons as there are cells in the matrix, each ribbon being associated with a cell and comprising, in the series of elementary images, at least the elementary image corresponding to said cell;

selecting on each ribbon, by making it scroll in the cell to which said ribbon is associated, the elementary image corresponding to said cell.

Before selecting the elementary image, it is possible:

to select an element (5) of the display device which comprises the cell of which one wishes to select the corresponding elementary image; and/or,

to select a zone, in particular a line or a column, of the display device, which zone comprises the cell of which one wishes to select the corresponding elementary image.

The ribbon can be wound as two spools by each of two of its respective longitudinal ends, the spools being on both sides of the cell and the ribbon being partially visible in the cell. Then, in order to select an elementary image, the rest of the elementary images can be made to scroll by unrolling one spool and rolling up the other.

Each ribbon can be advantageously mounted in a removable cassette, so that in order to replace a first ribbon in a cell by a second ribbon, a first cassette containing the first ribbon can be replaced in the display device by a second cassette containing the second ribbon.

According to another aspect of the invention, a display device comprises a matrix of cells, each intended for the display of an elementary image which is part of the formation of an aggregate image in the matrix, this elementary image being supported by a ribbon. The ribbon can contain a series of elementary images which can be displayed in the cell that it equips, each of said elementary images being part of the display of one or more aggregate images.

When the ribbon is wound onto two spools, according to a first embodiment, a selection mechanism for an elementary image can contain a drive belt maintained under pressure against the spools so that when said belt is in movement, one of the spools unrolls as much as the other one rolls up. If each spool rolls up on a roller, according to a second embodiment, each roller can be equipped with a disk which is coaxial with the roller, and a selection mechanism for an elementary image contains the drive means for driving the disk of one of the rollers in rotation, in particular by friction or by meshing or by a contactless means, so that the ribbon rolls up around one of the rollers when scrolling in the cell.

The device can moreover contain a selection mechanism for an element of the panel corresponding to a respective cell, of which one wishes to select an elementary image.

According to the first embodiment, the selection mechanism for an element can contain a unit which is mobile from one element to the other, said mobile unit comprising a wheel which rotates freely in order to roll on a face of the drive belt and to press an opposite face against the spools of the selected element. It can moreover contain a displacement belt on which the mobile unit is fixed so that a movement of said displacement belt makes it possible to move said mobile unit from one element to another.

According to the second embodiment, the selection mechanism for an element can contain a unit which is mobile in displacement along an endless screw and supporting a wheel for driving the disk of one of the rollers in rotation. The mobile unit can also contain two wheels for driving the disks of the rollers of a same element, arranged so that a first one can drive the disk of a first roller without the second driving the disk of the second roller. These wheels are advantageously arranged so that a minimal displacement of the unit is sufficient that the first wheel can no longer drive the disk of the first roller and that the second wheel can drive the disk of the second roller. Each wheel for driving a disk can be toothed and the drive mechanism moreover contains a grooved rod meshing with the toothed wheel in order to drive said toothed wheel in rotation.

A display plate can be provided in order to realize the cell, a visible part of the ribbon being held tight on said plate. The ribbon can be wound onto two spools by each of two of its respective longitudinal ends, the spools being either side of the cell, the ribbon being partially visible in the cell.

The display device can advantageously contain a mechanism for varying the aggregate image. The mechanism for varying the images can itself contain a mechanism for selecting an elementary image on the ribbon.

Each spool can be envisaged rolling on a roller, each roller being equipped with a disk coaxial with the roller, and the selection mechanism for an elementary image can contain drive means for driving the disk of one of the rollers in rotation, in particular by friction or by meshing, so that the ribbon rolls up around said one of the rollers by scrolling in the cell.

The drive means can, for example, contain a wheel driven in rotation by a grooved rod.

The drive means can, according to a variant, contain a belt mounted between two pulleys of which a first pulley is motorized, the assembly constituted by the belt and the pulleys being able to be swung against the disk. In this variant, the device can contain a swinging arm which is mobile in rotation about a common axis with the motorized pulley, the second pulley being mounted on the swinging arm, the swinging arm being able to be swung into a position in which the belt is in contact with the periphery of the disk without slipping.

According to another variant, the drive means can contain two rollers mounted on an arm, so that they are held there at a constant distance from each other and can roll one on the other without slipping, a first roller, from the two, being integral in rotation with the shaft of a motor and the second roller being envisaged to be brought into contact with the disk and roller without slipping on the periphery of said disk.

The device can also comprise a selection mechanism for an element of the panel, said element corresponding to a respective cell from which it is sought to select an elementary image, said element comprising the ribbon.

The device can also contain a brake for immobilizing the ribbon in a chosen position.

The device can contain an index, for example for identifying and/or positioning an elementary image on the ribbon. This index can be, for example, a bar code or a reflected binary code. It can in particular be written somewhere other than on the back of the image which it can identify and/or position. For this purpose, the device can advantageously contain means for reading (62) the index.

The device can contain a selection device for an element having a mobile unit which can be moved to the right of at least some elements, said mobile unit comprising a motor in order to make the ribbon scroll in each of said elements.

The ribbon can be mounted on a removable support.

At least one cell can be associated with a respective motor in order to make the ribbon scroll in said cell.

The device can contain a cleaning device for the ribbon.

The device can also comprise, between two neighbouring ribbons, a diffusion device for colouring on at least one of the ribbons.

Other features and advantages of the invention will also become apparent from the description below, relating to non-limitative examples.

In the attached drawings:

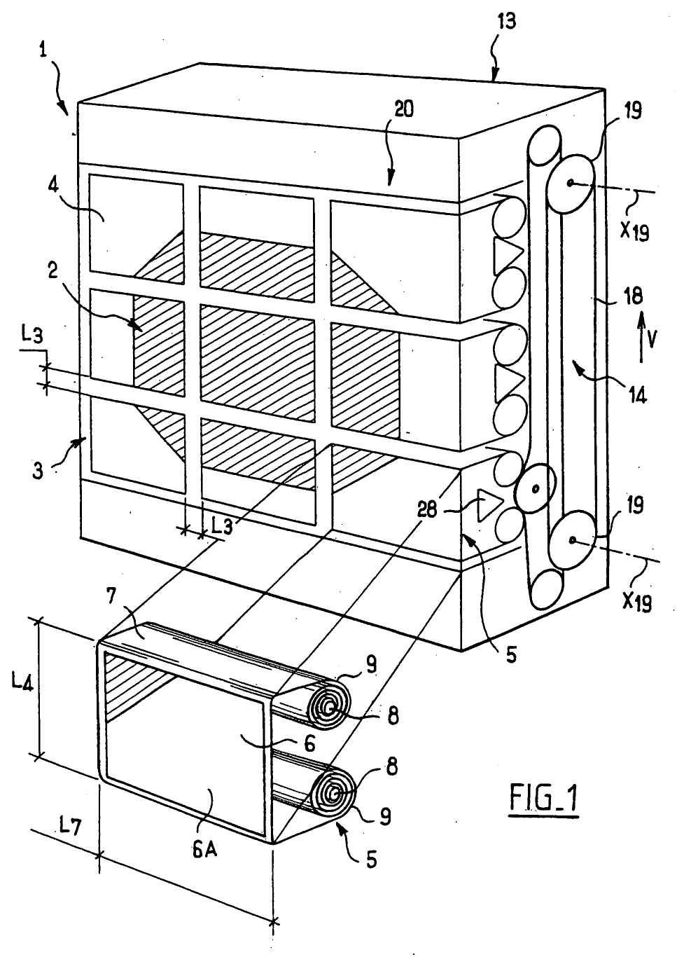

FIG. 1 is a diagrammatic representation of a display device according to the invention, comprising a mechanism for varying the display according to a first embodiment, an element of the device being represented partially and diagrammatically in a magnified view at the front of the device;

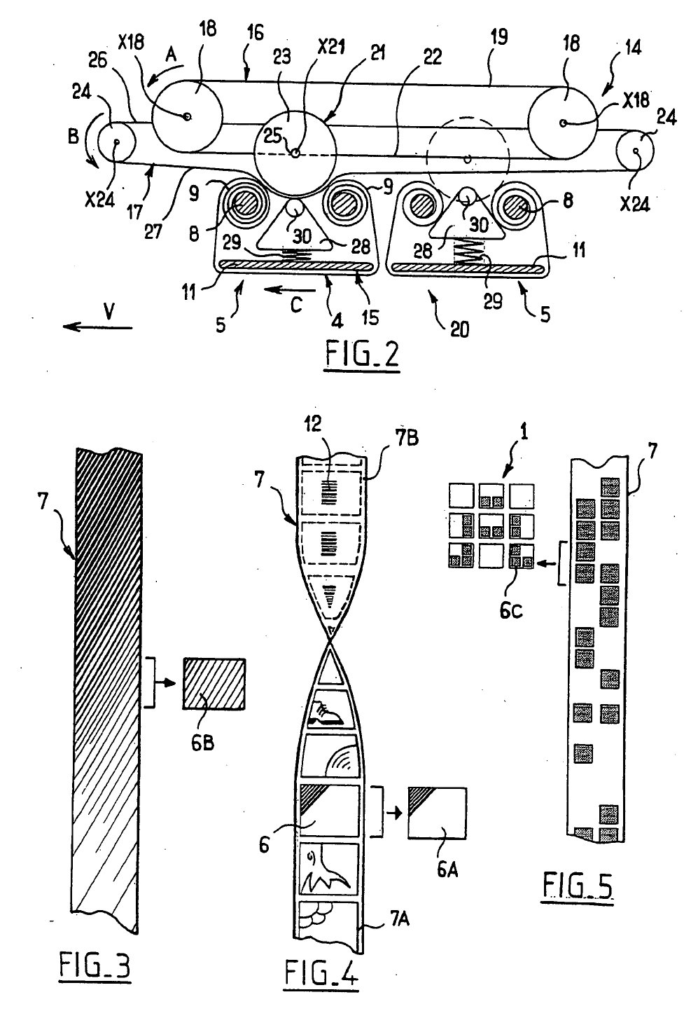

FIG. 2 is a diagrammatic representation of the first embodiment of a mechanism for varying the display;

FIGS. 3 to 5 represent different types of printing on ribbons in order to form elementary images;

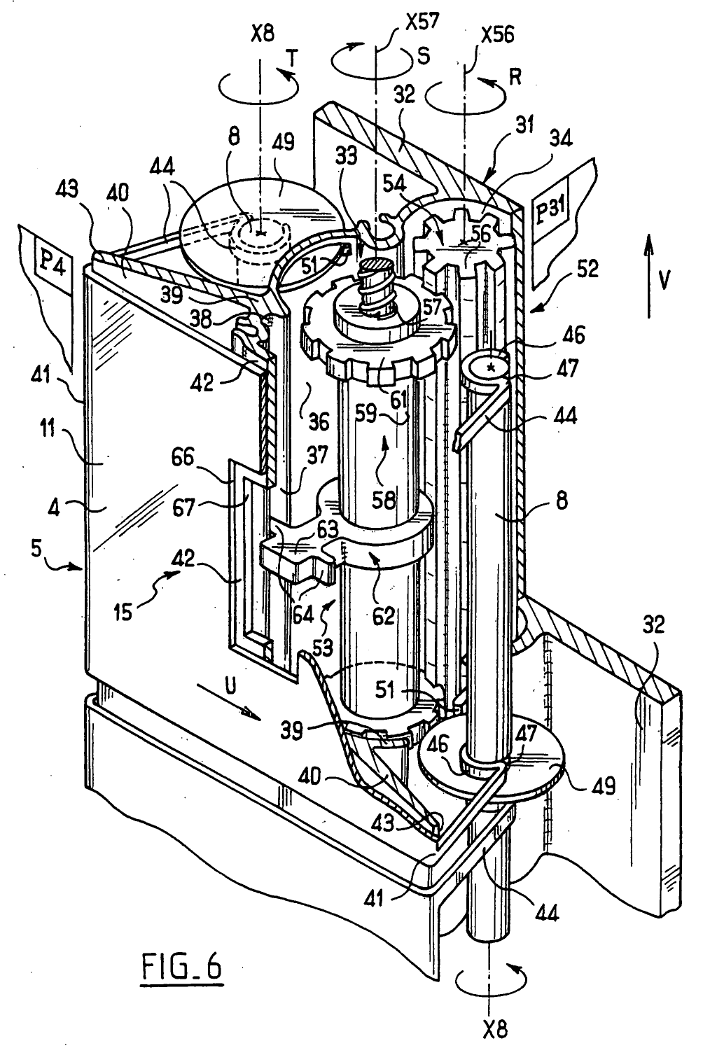

FIG. 6 is a representation, in perspective and in section, at the level of an element of a display device according to the invention comprising a mechanism for varying the display according to a second embodiment;

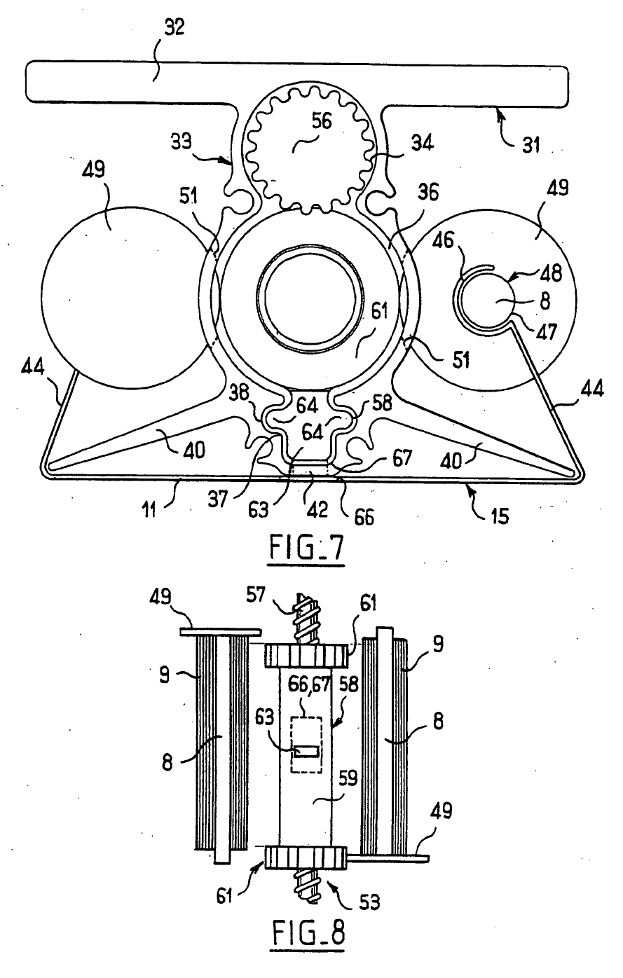

FIG. 7 is a horizontal section at the level of the element of FIG. 6; and,

FIG. 8 is a partial elevation at the level of the element of FIGS. 6 and 7;

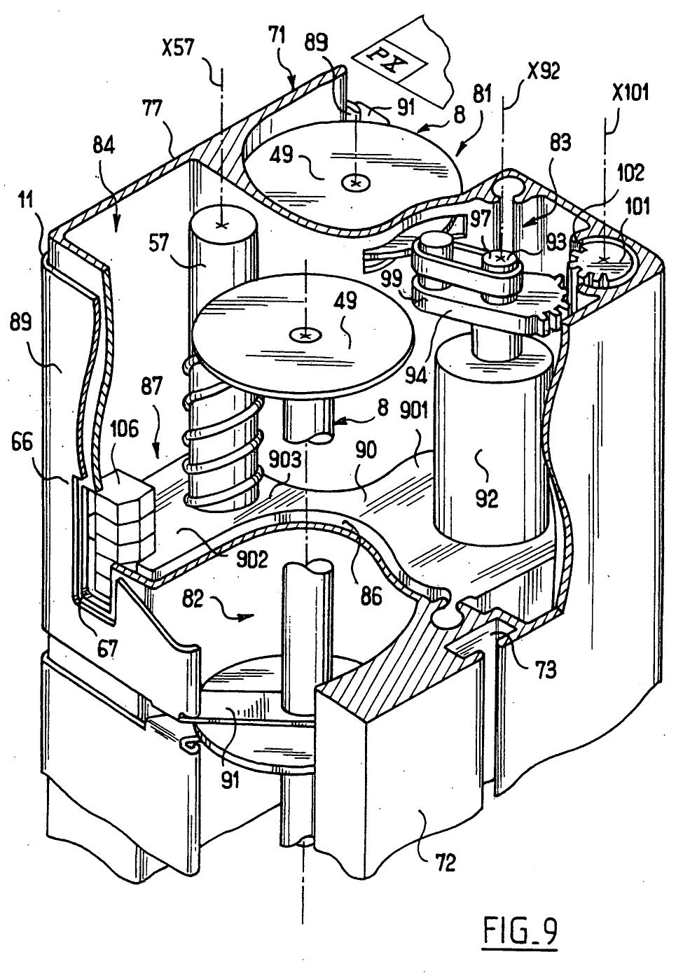

FIG. 9 is a perspective representation, in a three-quarter perspective view from the back and in section, at the level of an element, of a display device according to the invention comprising a mechanism for varying the display according to a third embodiment;

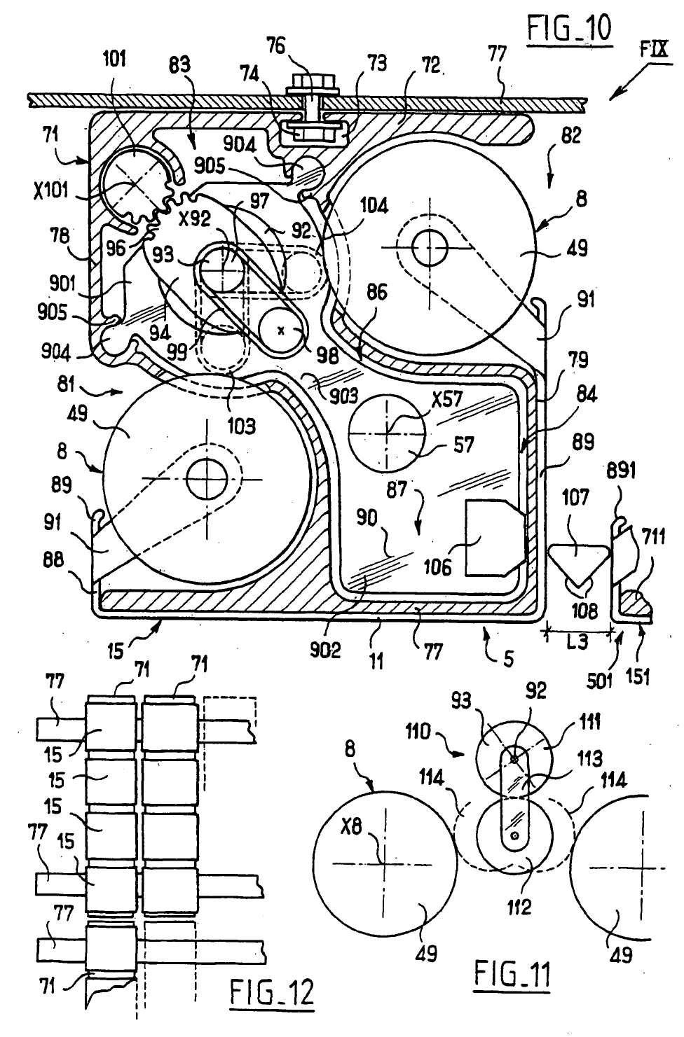

FIG. 10 is a horizontal section at the level of the element of FIG. 9;

FIG. 11 is a partial and diagrammatic representation, at the level of an element, of a mechanism for varying the display according to a fourth embodiment, neighbouring the third; and,

FIG. 12 is a diagrammatic representation seen from above of a possible arrangement for profiles comprising several elements for devices according to second, third and fourth embodiments.

FIG. 1 represents a device according to the invention produced in the form of a panel 1. For the purposes of the description, the panel 1 has small dimensions. It allows a matrix display of a variable aggregate image 2, in other words several aggregate images can be displayed there successively. The image represented displayed in FIG. 1 is that of a monochrome octagon on a white background. The matrix display is produced according to a matrix 3, rectangular and flat, of nine cells 4 split into three horizontal rows and three vertical columns of three cells each. The matrix 3 forms a large part of the front face, i.e. the principal visible face of panel 1. Each cell 4 is the visible part of an element 5 of the display device. Each element 5 allows the display of an elementary image 6 in a respective cell 4, the juxtaposition of the elementary images allowing the aggregate image 2 to be constituted in its entirety.

Each element 5 comprises a ribbon 7 serving as a support for the elementary images 6. These elementary images can be produced thereon by any means, in particular by any printing, painting or photographic means. The ribbon can thus be a positive or negative photographic film. Advantageously it will be used a ribbon made of printed paper which is inexpensive.

The ribbon 7 is fixed at each of its longitudinal ends on a respective roller 8. Each roller 8 allows the rolling up of the ribbon starting from one of its respective ends, forming a spool 9. The ribbon 7 is held tight at the level of the cell 4 on holding means. These holding means can contain a display plate 11 (see FIG. 2) against which the ribbon is pressed. Each of the rollers 8 is arranged on either side of the plate 11. Thus, when one of the spools 9 is unrolled, the other can roll up on its respective roller so that the ribbon is held tight and pressed on the plate 11, and so that the elementary images 6 succeed each other in the cell 4 of the element 5.

The rollers, therefore the spools, can be arranged horizontally, as illustrated in FIG. 1 or vertically as illustrated in FIG. 6 or in any other position suited to the shape of the panel. The rollers 8 and the plate 11 are advantageously part of a removable part 15 of an element 5, such as a cassette 15. Thus, a ribbon can be mounted in a cassette in advance, so that in order to change a ribbon in the panel, it is only necessary to remove a first cassette containing a first ribbon to be changed and to introduce a new cassette containing a new ribbon, in particular for replacing images which can be displayed by the panel. This same operation can be carried out in order to replace a faulty ribbon at low cost.

Typically, it can be envisaged that the width L7 of a ribbon 7 is six centimetres. Thus, common printing means make it possible to print numerous ribbons inexpensively, rather than using special machines for printing large images. It can also be envisaged that each cell is square, with a height L4 of around six centimetres itself. An operating margin L3 can be provided between two adjacent images, for example around three to five millimetres. Thus, on the type of panel 1, an aggregate image of two metres by two metres can be reconstituted from a matrix of nine hundred cells arranged in thirty rows and thirty columns. However, such a display device can be envisaged to cover much larger surfaces, for example 800 or 1000 square metres. It is particularly suited for entirely covering the blank walls of buildings.

Each elementary image on the ribbon can be individualized or not. Thus, in FIG. 3, the ribbon comprises a single colour the intensity of which is graduated according to the length of the ribbon, from black to white, continuously, i.e. without different intensities being individualized so as to each form an image having the dimensions of an elementary image. Each element thus allows the display of a monochrome pixel of a chosen intensity 6B by selecting along the gradation a portion of average intensity equal to the intensity chosen. Thus, by using in three juxtaposed elements, three respective ribbons each comprising respectively a gradation of one of the three primary colours, it is possible to reconstitute an image, as on a video monitor, from a sufficient number of these groups of three elements.

The ribbon 7 represented in FIG. 4 comprises a succession of individualized elementary images 6. This ribbon is provided in order to be arranged in the lower left hand element of panel 1 and it comprises in particular the elementary image 6A which is part of the aggregate image 2 of FIG. 1. The other elementary images of this ribbon are provided in order to be part of other aggregate images.

The ribbon in FIG. 4 is represented twisted. Thus, below the twist its front 7A is intended to be seen, and above the twist its back 7B. The front comprises a succession of elementary images which are different from one another, each being a part of an aggregate image. On the front and at the level of each of the elementary images, the ribbon comprises indexes, here bar codes 12, respectively associated with each of the elementary images and making it possible to identify and position each of these elementary images.

The ribbon 7 represented in FIG. 5 comprises a combination of pixels, i.e. in the example illustrated, a succession of lines each comprising one, two or no square-shaped black pixels. The lines are intended to be displayed two-by-two and form an elementary image 6C comprising a desired combination of one, two, three, four or no pixels. The use of such ribbons is suited to the display of images of an essentially alphanumeric type. By way of example, the panel 1 in its configuration of FIG. 5 allows the letter A to be displayed.

Of course, the same ribbon can contain characteristics of each of the ribbons of FIGS. 3 to 5. Thus, a panel equipped with such ribbons, can either display an aggregate image of the illustration type using three types of coloured pixels or using elementary images which are parts of said image, or also an aggregate image of the alphanumeric type using a reduced number of black pixels. The three types of displays can also be combined within the same aggregate image.

As illustrated in FIG. 1, the panel 1 comprises an enclosure 13 serving as a frame for the panel 1. The panel 1 comprises, at the back of the matrix 3 and inside the enclosure 13, a mechanism 14 making it possible to vary the display, i.e. modifying the aggregate image 2.

FIG. 1 and FIG. 2 illustrate a first embodiment for such a variation. In these figures, the arrow V, pointing upwards, represents the vertical direction. Each column 20 of the matrix has its own variation mechanism. This mechanism makes it possible to unroll each ribbon in order to display a chosen elementary image. The variation mechanism comprises two sub-units 16, 17. One of the sub-units is a mechanism 16 for the selection of an element 5, from those of the column thus equipped. The other is a mechanism 17 for the selection of an elementary image 6, from the elementary images which can be displayed by this selected element 5.

The mechanism 16 for the selection of an element comprises two displacement pulleys 18 mounted on respective horizontal axes X18, parallel to the axes X8 of the rollers 8, respectively in the upper part and in the lower part of the panel 1. A flexible displacement belt 19 is held tight vertically between the two displacement pulleys 18. The mechanism for the selection of an element also comprises a mobile unit 21. The mobile unit comprises an equipment shaft 25, with an equipment pin with axis X21, attached on a side 22 of the belt 19, which is furthest in front of the panel. The equipment pin is parallel to the axes X8 of the rollers. The mobile unit also comprises a so-called presser wheel 23 mounted so that it can rotate freely about the equipment shaft 25. One of the displacement pulleys 18 is a motorized pulley so that it allows the mobile unit to be moved from the top to the bottom, parallel to the column 20 thus equipped.

The mechanism 17 for the selection of an elementary image comprises two drive pulleys 24 mounted on horizontal axes X24, parallel to the axes X8 of the rollers 8, respectively in the upper part and in the lower part of the panel 1, respectively beyond the displacement pulleys. The mechanism 17 for the selection of an elementary image also comprises a flexible drive belt 26 held tight vertically between the two pulleys 24. The drive belt is arranged so that a rear face of its segment 27 the furthest in front serves as a rolling surface for the presser wheel 23. This segment the furthest in front is arranged so that it is only tight between the two drive pulleys, without the presence of the wheel, it is situated behind the spools 9 formed by the ribbons 7 of the elements 5 of the column 20, without the possibility of contact with said spools. One of the drive pulleys 24 is a motorized pulley.

The selection mechanisms 16, 17 are arranged in such a way that, as illustrated in FIGS. 1 and 2, the presser wheel, by bearing on the rear face of the drive belt, deforms it elastically so that the front face of the drive belt is in contact with one or two spools 9.

In order to select an element chosen from the elements of the column 20, the drive belt is held immobile and the mobile unit 21 is moved using the motorized displacement pulley until the drive belt is in contact with the two spools 9 of the element 5 thus chosen.

Then, in order to select an elementary image chosen from those of the element 5 previously chosen, the displacement belt 22 is immobilized and the drive belt is set in motion. In its movement, the drive belt drives in rotation, the presser wheel and the spools against which the drive belt is pressed by the presser wheel. Thus, when one of the spools unrolls, the other rolls up, making the elementary images scroll along the plate 11 in the cell 4 of the element 5 selected, until the elementary image chosen is selected.

Thus when the highest drive pulley is rotated according to B, so that the side the furthest in front 27 of the drive belt 26 moves from top to bottom, the lower spool of the element chosen unrolls while the upper spool rolls up, the elementary images scrolling from the bottom to the top according to B in the cell 4.

For example in the situation illustrated in FIG. 2, if it is sought to select a second element 5 situated immediately under the first element chosen previously, the upper displacement pulley is rotated according to A, so that the furthest forward segment of the displacement belt moves from top to bottom, together with the mobile unit which is linked to it, and the presser wheel passes over, by rolling on the drive belt and by elastically deforming the displacement belt 19, successively the lower spool of the first element, then the upper spool of the second element. The wheel is then immobilized between the two spools of the second element so as to press the drive belt against said spools.

Each element 5 also comprises a brake 28 for the spools 9. The brake is in the shape of a wedge. It is arranged at the rear of the display plate 11. A spring 29 tends to distance it from the plate and brings it closer to the spools. When an element is not selected, the brake forces itself between the two spools of this element, so that the brake immobilizes these two spools by becoming wedged between them. Thus, the elementary image displayed by this element is retained unchanged. When this element is selected, the presser wheel 23, by forcing itself from the rear between the two spools, pushes back the brake, freeing the spools and allowing the subsequent selection of another elementary image.

Each brake 28 comprises a roller 30 which is rotationally mobile about a horizontal pin, arranged at the rear of the brake. Thus, when the element is chosen, the drive belt 26 is pinched between the roller 30 and the wheel 23. When the drive belt is set in motion, the roller rolls on the belt, thus limiting the transmission of vertical stress by the belt to the brake.

A second embodiment for a selection mechanism for a panel according to the invention will now be described, with reference to FIGS. 6 to 8. In this second embodiment, the structure of each column is produced by a profile 31 made of extruded aluminium arranged vertically. The horizontal section of this profile is substantially constant over all of the height of the profile. The profile 31 is symmetrical relative to a vertical plane P31, perpendicular to a plane P4 comprising the cell 4. The plane of symmetry P31 of the profile 31 also forms a plane of symmetry for the cell 4.

In FIG. 6, the profile 31 is cut horizontally to the left of the plane of symmetry P31, slightly above the upper part of the plate 11. To the right of the plane of symmetry P31, the profile 31 is cut horizontally, slightly above the lower part of the plate 11. These two half-sections are connected to each other by a vertical section of the profile according to the plane of symmetry P31.

The profile comprises, at the rear, a flat section 32 which extends either side of the plane of symmetry P31, serving as a base for the profile and for its mounting in the display device. The profile 31 also comprises a tube 33 with a complex horizontal section extending towards the front from the flat section 32. This tube comprises successively, from the back to the front, a drive housing 34, a displacement housing 36, and a front housing 37. The drive 34 and displacement 36 housings have approximately the shape of two cylinders which intersect each other, with respective axes X56 and X57. Two guide channels 38 are formed vertically on either side of the anterior housing. The three housings and the channels communicate with each other, so that they only form a single tubular volume.

The profile also comprises two wings 40, extending both forwards and laterally, on either side of the tube 33, from a respective junction of the displacement housing 36 and the front housing 37. The wings have a small thickness, of the same order as that of the walls of the tube. The thickness of the flat section 32 is greater than the other thicknesses of the profile 31.

In order to hold the ribbon 7 (not represented in FIGS. 6 and 7) of an element 5, a cassette 15 is used comprising a display plate 11. This plate is rectangular; it forms the cell 4.

Towards the front, the free edges 43 of the wings of the profile 11 are in the same plane as a face 42 the furthest forward of the tube. The rear of the display plate 11 bears against the free edges 43 of the wings and the front face 42 of the tube.

Laterally, the wings 40 extend approximately as far as the lateral edges 41 of the display plate 11. Horizontal brackets 44 extend from each angle of the plate symmetrically approaching the plane of symmetry P31, thus forming an acute angle with the rear of the plate. Thus, the cassette is mounted on the profile by simple clipping of the brackets on the wings.

In this second embodiment, the rollers 8 of the cassette 15 are arranged vertically in the cassette 15. Each bracket 44 comprises at its free end an external bearing 46 cooperating with an internal bearing 47 respectively of a roller 8. The internal bearings have a diameter less than that of the roller which holds them, so that the roller is immobilized vertically by the brackets. Therefore, each roller 8 is held between an upper bracket and a lower bracket, each extending respectively from an upper end and a lower end of the same vertical edge 41 of the display plate 11.

The external bearings 46, are open; i.e. they do not completely encircle the internal bearing 47, but at least more than half a circle. Thus, a peripheral opening 48 is arranged in the external bearing. The external bearing 46 is elastically deformable, so that the internal bearing 47 can be mounted in the external bearing 46 simply by radial clipping, through the peripheral opening 48.

Each of the two rollers of the same cassette comprises, at one of its ends, a disk 49, coaxial with its respective roller. For one (represented on the left) of the two rollers the disk is above its upper bracket, for the other (represented on the right) of the two rollers the disk is under its lower bracket.

The ribbon bearing the elementary images rolls up between the brackets supporting the same roller. The minimal distance between two superimposed elementary images is the sum of the thicknesses of two neighbouring brackets and of a disk between these two brackets. These thicknesses are therefore, preferably, minimal, so as to reduce as much as possible the distance, i.e. the width L3 of the operating margin between two elementary images immediately superimposed.

The rollers are arranged in the cassette 15 so that when the cassette is mounted on the profile, each disk 49 partially penetrates into the displacement housing 36 through a respective horizontal slit 51 made in a wall of this housing.

As in the first embodiment, each column of the matrix comprises its own variation mechanism 52 making it possible to unroll each ribbon in order to display a chosen elementary image. The variation mechanism comprises two sub-units 53, 54. One of the sub-units is a mechanism 53 for the selection of an element 5 from those of the column thus equipped. The other is a mechanism 54 for the selection of an elementary image from the elementary images which can be displayed by this element 5.

The drive housing 34 contains a grooved rod 56, coaxial with the axis X56 of this housing 34 and mounted mobile in rotation about this axis X56.

The selection mechanism for an element 5 is a displacement mechanism 53. It comprises a vertical threaded rod 57 arranged in the displacement housing 36, coaxial with this housing 36 and mounted mobile only in rotation about its axis X57. The displacement mechanism 53 also comprises a mobile unit 58 mounted on the threaded rod 57.

This unit comprises a tapped body 59 cooperating with the threaded rod. It is cylindrical and coaxial with this rod. A toothed wheel 61 is mounted at each of the ends, respectively at the top and at the bottom, of the body 59 of the unit. The two toothed wheels rotate freely about the body and mesh with the grooved rod 56. A sensor 62 is attached to the body 56, approximately half-way between the two toothed wheels 61. The sensor is locked in rotation around the body. The sensor extends towards the front from the body 56. The sensor comprises a reading head 63 which penetrates into the front housing 37. The rotation of the body is thus locked by the engagement of the head inside the front housing so that a rotational movement of the threaded rod about its axis X57, causes the vertical displacement, without rotation, of the unit. A finger 64 extends from each side of the head. Each of the two fingers 64 engages in a respective guide channel 38. The fingers cooperate with the channels in order to ensure the correct positioning of the reading head 63 relative to the front face 42 of the profile 31.

In order to select an element chosen from the elements of the column, the grooved rod is held immobile and the mobile unit 53 is displaced thanks to the rotation of the threaded rod 57 about its axis X57, until the mobile unit 53 is between the two spools 9 of the element 5 thus chosen. A rotation according to S of the threaded rod causes the unit to rise, a rotation in the opposite direction to S causes it to descend.

The horizontal distances between the axes X8 of the disks 49 and the axis X57 of the toothed wheels as well as the diameters of the toothed wheels and the disks are chosen so that when a toothed wheel is at the same height as a disk, the latter can be driven in rotation by friction on an external surface of the toothed wheel, when this wheel turns.

The vertical distance between the two toothed wheels 61 is such that, when an element is selected, only one toothed wheel can be in contact with one of the disks. For example, as illustrated in FIGS. 6 and 8, the lower toothed wheel is in contact with the lower disk, mounted on the right-hand roller, while the upper wheel, is not in contact with the upper disk mounted on the left-hand roller. The vertical distance between the two wheels is only slightly less than the vertical distance between the two disks. Thus, a small upwards displacement makes it possible for the upper wheel to contact the upper disk and to remove the contact between the lower wheel and the lower disk.

The toothed wheels have the external shape of a barrel, i.e. the external surface of each tooth is vertically convex. Thus, during displacement of the unit, the contact of a toothed wheel with a disk is progressive. The disk is thus progressively pushed back towards the outside of the tube and under an elastic return effect produced by the induced deformation of the brackets, the frictional force is at a maximum over the widest part of the toothed wheel.

The display plate 11 comprises at its centre a rectangular window 66 which is superimposed on a similar window 67 in the front face 42 of the tube 31. When the element is selected, and whichever disk of this element is in contact with a toothed wheel, the reading head is always situated behind the windows. Thus, if the element uses a ribbon of the type illustrated in FIG. 4 and comprising on the back of it indexes, for example bar codes 12, these can be read by the reading head 63 through the windows 66, 67 when the ribbon scrolls in front.

Thus, when the element has been selected, in order to select an elementary image from those of the element 5 chosen previously, one of the toothed wheels is placed in contact with a respective disk and the threaded rod 57 is immobilized, thus determining the scrolling direction of the ribbon. As illustrated in FIG. 6, the right-hand rotation of the grooved rod 56 according to R about its axis X56, drives the toothed wheels in left-hand rotation about their axis X57, with only the lower wheel driving the lower disk, therefore the right-hand roller in right-hand rotation and consequently the rolling up of the ribbon around this same right-hand roller and its scrolling from left to right on the display plate 11. In order to change the direction of scrolling of the ribbon, the mobile unit must be moved slightly in order to bring the other toothed wheel into contact with the other disk of the same element, then to reverse the direction of rotation of the grooved rod.

The indices on the back of the ribbon allow the identification of a respective elementary image and the positioning of this image in the cell. Thus, during the scrolling of the ribbon in front of the windows 66, 67, the reading head identifies and selects the elementary image chosen, then positions it.

The length of the threaded rod 57 is such that it allows the positioning of the mobile unit 53 at the level of each of the elements 5 of the column thus equipped. The length of the grooved rod is such that the toothed wheels 61 are always meshed with the grooved rod, whichever the element selected in this column and the chosen scrolling direction.

A third embodiment for a selection mechanism for a panel according to the invention will now be described, with reference to FIGS. 9 and 10. In this third embodiment, the structure of each column is shown by a profile 71, made of extruded aluminium, arranged vertically. In FIG. 9, a display element 5 is seen in a perspective three-quarter view from the rear on the right along F IX. Thus, its front face, i.e. the one seen by an observer of the display, is not visible in this figure, and the right and rear sides (according to the same observer) of the display element are principally visible.

The horizontal section of this profile is more or less constant over the entire height of the profile. The horizontal section of an element, as represented in FIG. 10, is approximately drawn within a rectangle.

In FIG. 9, the profile 71 is cut horizontally at the top of the element according to a plane P X, except in the rear right angle, where the profile is cut at the bottom of this element, so that the inside of the element 5 is visible in the figure. One of the rollers is only partially represented there so that the view of the inside of the element is unimpeded. FIG. 10 is a horizontal section according to the plane P X.

The profile 71 comprises, at the rear, a rear flat section 72 parallel to the display, i.e. parallel to the general plane of the display panel with which it is part. This flat section serves as a base for the profile and its mounting in the display device. For this purpose, the flat section 72 comprises a vertical rail 73, which is recessed into the flat section, intended to receive a head 74 of a bolt 76 (see FIG. 10). This bolt allows the profile 71 to be attached to a support 77, defining the geometry of the display panel. The principle of the composition of a display device using profiles according to the invention fixed to a suitable support is explained below with reference to FIG. 12.

The profile 71 comprises, at the front, a front flat section 77 parallel to the display, i.e. parallel to the general plane of the display panel of which it is part. This flat section serves as a bearing surface and a reference for the display plate 11.

Between the two flat sections 72, 77, the profile defines four housings, divided up such that in FIG. 10 each of the housings occupies a respective angle of the section of the profile.

A first vertical wall 78 of the profile extends towards the front from the rear left angle of the profile, firstly along the left-hand side, up to approximately the middle of this side, then connecting the regions of the middle of the front flat section. This wall thus defines a first housing 81 in the front left angle of the profile, opening onto the left-hand side of the profile, at the front of the first wall 78.

A second vertical wall 79, similar to the first wall 79, extends towards the rear from the front right angle of the profile, firstly along the right-hand side, up to approximately the middle of this side, then connecting the regions of the middle of the rear flat section. This wall thus defines a second housing 82 in the rear right angle of the profile, opening onto the right-hand side of the profile, at the rear of the second wall 79.

The two walls 78, 79 and the front 77 and rear 72 flat sections define between them an internal tubular volume closed laterally. The walls have shapes which are generally symmetrical to each other (as much as possible for a profile if its section is not square) relative to a vertical diagonal plane extending from the rear left angle to the front right angle of the profile. Thus these two 5 walls are closer to the vicinity of the centre of the section of the profile and form at this point a contraction in area 86. The internal volume comprises a third housing 83 and a fourth housing 84 respectively at the rear and at the front of the contraction in area 86.

A mobile unit 87 is mounted sliding in the tubular volume 83, 84, 86. The mobile unit comprises a body 90 a first part 901 of which occupies the third housing and a second part 902 occupies the fourth housing. The body also comprises an isthmus 903 connecting these two parts 901, 902 in a rigid manner.

The mechanism for the selection of an element 5 is a displacement mechanism. It comprises a vertical threaded rod 57 arranged in the displacement housing 84 and mounted mobile only in rotation about its axis X57. The second part 902 of the block 90 is screwed on the threaded rod 57, so that a rotation of the threaded rod 57 causes the displacement of the block and therefore the unit, from the top to the bottom or from the bottom to the top along the profile 71, in the internal tubular volume 83, 84, 86.

The first part 901 of the block comprises two guide appendices 904 cooperating with two guide rails 905 in order to ensure the guiding in displacement and the positioning of the unit and also to prevent the driving in rotation of the unit under the action of the threaded rod 57. Each of the rails is produced in one of the vertical walls 78, 79 respectively.

The first and second housings are provided in order to receive respectively a roller 8 to the left of the display cell and a roller 8 to the right of the cell. The third housing is a drive housing and the fourth is a displacement housing.

A cassette 15 for holding the ribbon (not represented in FIGS. 9 and 10) comprises a folded sheet of metal 88 in a U-shape and two rollers 8. The bottom of the U is constituted by the display plate 11, bearing on the front flat section 77 of the profile 71. Each branch of the U is constituted by a return 89 produced by folding the metal sheet and extending it towards the rear respectively along the left-hand side and the right-hand side of the profile, up to the level of the first housing 81 and of the second housing 82 respectively. From each return 89, two brackets 91 extend horizontally into the respective housing 81, 82, one from the top, the other from the bottom of the return. The brackets are also produced by folding the metal sheet 88. Each of the brackets 91 comprises a bearing for holding a respective roller 8, respectively above and below a zone of the roller provided for the rolling up of the ribbon.

Each of the two rollers 8 of the same cassette comprises, at its upper end above its upper bracket, a disk 49, coaxial with its respective roller. The rollers are arranged in the cassette 15 so that when the cassette is mounted on the profile 71, each disk 49 penetrates partially into the drive housing 83 through a respective horizontal slit 51 made in one of the walls 78, 79 of this housing respectively.

Each cassette is envisaged to be introduced by an upper or lower end of the profile, then slid along the latter to its position provided for the display. The cassettes on the same profile are therefore introduced successively, in the order of their display along the profile. The folded sheet of metal 88 is provided with sufficient flexibility so that during the introduction of the cassette 15 it is possible to move the returns 89 away from the sides of the profile, and thus, prevent the disks 49 from interfering with the vertical walls 78, 79.

The device for driving the ribbon comprises a direct current and bidirectional rotary motor 92, attached to the first part 901 of the body of the mobile unit. The axis of rotation X92 of the motor 92 is vertical and a drive shaft 93, with the axis of rotation X92 of the motor as its axis, is orientated upwards.

The drive device also comprises a swinging arm 94 mounted so that it can freely rotate about the drive shaft. The swinging arm comprises a posterior grooved zone 96. The drive shaft passes through the swinging arm and it forms a first motorized pulley 97 in its part situated above the swinging arm. A second pulley 98 is mounted on an anterior part of the swinging arm 94 opposite the posterior part 96 relative to the shaft of the motor 92. This second pulley is mounted so that it can rotate freely relative to the swinging arm. A belt 99 is mounted under tension on the two pulleys 97, 98, so that the rotation of the motor 92, therefore of the first pulley 97, causes a movement of the belt around the two pulleys 97, 98.

The drive device also comprises a grooved rod 101. It is mounted in rotation about an axis of the grooved rod X101, in a bearing 102 formed in the rear left angle of the profile 71, so that it meshes with the posterior part 96 of the swinging arm 94 and a rotation of the grooved rod about its axis X101 causes the swinging arm to swing about the motor axis X92.

The selection device is arranged in the selection housing so that there is a first position 103 of the swinging arm for which the belt 98 is in contact with the periphery of the disk 49 of the left-hand roller 8, and a second position 104 of the swinging arm for which the belt 98 is in contact with the periphery of the disk 49 of the right-hand roller 8. In FIGS. 9 and 10, the swinging arm is represented in thick lines in an intermediate position between these two positions. Only the belt and the second pulley are represented in the first and the second position, in dotted lines.

The rod 101, is only partially grooved, mobility of the swinging arm 96 being required only between its first and second positions.

If it is sought to roll up the ribbon around the left-hand roller, the swinging arm is swung into its first position 103, using the grooved rod 101, then the rotation of the motor 92 is started, so that it drives, via the belt, the rotation of the disk, therefore of the roller in a suitable direction for the rolling up of the ribbon. The procedure is carried out in a similar manner in order to roll up the ribbon around the right-hand roller. It is thus possible to select one of the elementary images on the ribbon, by rolling it up around one or the other of the rollers.

The mobile unit also comprises, mounted on the second part 902 of the body 910, a reading head 106. This reading head is provided in order to read an index on the back of the ribbon. This index is a reflected binary code, i.e. it can be read whatever the scrolling direction of the ribbon. The reading head 106 is arranged opposite the right-hand side of the profile, i.e. the reading of the index takes place through a window 66 in the return 89 to the right of the cassette 15, and a similar superimposed window 67, in the second wall 79. The index is therefore not written directly on the back of the elementary image for which it codes the position, but offset, so that when this image is displayed in the cell, the index has been read by the reading head and if this elementary image has been selected, the ribbon can be immediately immobilized.

Such an arrangement of the reading head is particularly advantageous when ambient light filtering through the ribbon is able to interfere with the reading of the code if this takes place through the display plate 11, as illustrated in the second embodiment.

To the right of the element 5, a neighbouring element 501, included on a neighbouring profile 711, is partially represented in FIG. 10. Only the left return 891 of the cassette 151 of this neighbouring element 501 is entirely represented. A cleaning device 107 is arranged between the two cassettes so that the ribbon of the cassette passes between the cleaning device 107 and the right-hand return 89 of the cassette 15 and so that the ribbon of the neighbouring cassette 151 passes between the cleaning device 107 and the left-hand return 891 of the neighbouring cassette. Particularly in urban environments, the ribbon risks rapidly becoming dirty in particular through dust being deposited on its displayed part. The cleaning device is provided to collect, for example by scraping on the ribbon, at least some of the dirt, when the ribbon scrolls at the level of the cleaning device.

The horizontal distance L3 between the two neighbouring elements 5, 501 is relatively small, for example 3 mm for images the horizontal dimension of which is of the order of 60 mm. However, it can be useful, for certain arrangements of the display device to hide the resulting interval. Thus, on either side of the elementary image displayed, a coloured zone is provided which harmonizes with the zone the closest to the elementary image this elementary image. Each coloured zone is envisaged to be displayed on a respective return of the cassette, opposite a diffusion device 107 for colouring the coloured zone.

In the example of FIG. 10, it is the same device 107 which serves both as a cleaning device and as a diffusion device. This device has a triangular horizontal section the tip of which is directed towards the front so that the front faces 108 of the device 107 serve as reflectors for the colouring. Thus, the interval between the neighbouring elementary images does not appear as a black line but as a colouring which harmonizes with the neighbouring elementary images, which makes it possible to either hide it or to integrate it with all of the aggregate image displayed.

FIG. 11 illustrates diagrammatically a fourth embodiment for a display device according to the invention. This third embodiment is closely related to the third, which has been described previously with reference to FIGS. 9 and 10. Here only the drive device is represented in as far as it differs from that of the third embodiment.

Instead of a swinging arm equipped with a belt mounted on two pulleys, the drive device 110 of FIG. 11 comprises two cylindrical rollers 111, 112 mounted on an arm 113, so that they are held there at a constant distance from one another and can roll on one another without slipping. The two rollers are mounted so that they can rotate freely relative to the arm 113. A first roller 111, of the two, is firmly attached in rotation to the drive shaft 93, one end of which is formed by it in the example described.

The drive device 110 is designed in such a way that a rotation of the arm 113 about the motor shaft 92, brings the second roller 112 into contact with one of the two disks 49 on the rollers, in one of the two positions 114 represented in dotted lines in FIG. 11.

The rotation of the drive shaft 93 about the axis of motor 92 drives in rotation about this axis, without deforming it, an assembly constituted by the two rollers and the arm, until the second roller 112 makes contact with one of the disks. The second roller being in abutment, the arm is immobilized while the rotation of the first roller 111 continues. Then, a rolling without slipping of the first roller on the second disk and of the second roller 112 on the periphery of the disk 49, makes it possible to start the rotation, about its axis X8, of the roller 8 thus selected, and as a result the rolling up of the ribbon around this roller. In order to roll up the ribbon round the other roller it is necessary to simply reverse the direction of rotation of the motor.

For the panels suited to this fourth embodiment it is therefore no longer useful to use a grooved rod for selecting a roller, the same motor makes it possible to select and drive this roller, whether or not this motor is fitted on a mobile unit.

FIG. 12 in particular illustrates an example of an arrangement for profiles 71 within a display device according to the invention. Each of the profiles constitutes a stack of four cassettes 15. The device also comprises supports 77 for the profiles 71. These supports are constituted by horizontal bars 77. Each profile is attached at the top and at the bottom to one of the bars. The profiles are arranged in horizontal lines comprising several profiles side by side and in vertical columns, comprising several profiles one above the other. The same mobile unit can be envisaged for sliding in several profiles of the same column.

Such an arrangement allows a display device in a large format to be assembled using elements with reduced size and weight, and therefore does not require the use of a costly and bulky washing material. Moreover, it is possible to equip each profile with its cassettes or to simply change a cassette on a profile, by handling only the profile considered, which is particularly advantageous in the case where the display device equips, for example, a facade of a building.

Such an arrangement, can be adopted in the same manner for one of the second, third or fourth embodiments of the display device.

Of course, the invention is not limited to the examples which have just been described and numerous changes can be made to these examples, without exceeding the scope of the invention.

The shape of the display device does not have to be that of a panel, i.e. planar. In particular, the matrix display allows by orienting an element differently to its neighbour, to give the display device another shape, for example the shape of a polyhedron which is approximately cylindrical, such as an advertising pillar, or even spherical.

If the ribbon is made of a transparent or translucent material, the display device can contain means for back-lighting at least some of the elementary images displayed. These back-lighting means can be individual or common to several elements.

The sizes of the cells, of the elements and therefore the ribbons, are not limited to those of the examples. These sizes can be different, in particular in order to be suited to the sizes and to the shape of a screen that they equip.

In particular, in order to be able to support a large number of elementary images on a single ribbon, it is possible to envisage that each elementary image has a dimension, measured according to the length of the ribbon, which is small relative to the width of the ribbon. Thus, for a ribbon scrolling vertically, such as in the first embodiment, each cell would be rectangular and of a height which is small relative to its width, which width is approximately equal to that of the ribbon. Thus the length of scroll of the ribbon and also, as a result, the tensile stress on the ribbon is reduced.

Thus, on the same ribbon it is possible to combine several intensities of several different colours. Taking into account the distance at which an aggregate image can be observed, a display with sixty four colours can suffice, each with 10 different intensities. It is possible to add to these colours black, white, gold, silver and a few fluorescent colours. Thus, with approximately 650 elementary images with a height, for example, of 2 mm each, i.e. a ribbon of approximately 1.30 metres, it is possible to represent under good quality conditions, almost any aggregate image. In this case, it is not useful to use 3 pixels of principal colours. It is also possible to use continuous gradations of each of the 64 colours, rather than 10 different intensities constituting 10 distinct elementary images.

The ribbon, instead of being rolled up at each of its ends, can form a loop which avoids having to carry out a complete respooling between two elementary images at two respective ends of the ribbon. Moreover this loop can be in the form of a Mobius strip, so that the entire surface of the ribbon is used, which makes it possible to double the number of the elementary images which can be supported by the same ribbon length.

Instead of each column being equipped with its own variation mechanism, the same variation mechanism can equip several columns, such a variation mechanism also comprising a sub-unit for the selection of a column, the display of which is sought to be varied among the columns thus equipped. It is also possible, rather than arranging a selection mechanism in each column, to arrange one in each line of the panel.

On the other hand, rather than the same variation mechanism making it possible to successively vary the display of several elements, each element can be equipped with its own variation mechanism. Such a variation mechanism reduces a selection mechanism for an elementary image to a single role. This makes it possible to simultaneously change the display of all the elements thus equipped, instead of the elements being selected successively.

If the panel is envisaged as being equipped with ribbons comprising series of elementary images all arranged in the same order as that envisaged for their respective aggregate images, a single variation mechanism can be used for the simultaneous changing of the display of all these elements. The only selection to be carried out by the mechanism being that of the aggregate image to be displayed.

In the context of the second embodiment, rather than toothed wheels, it is possible to use wheels at least the periphery of which is made of a flexible material, for example a foam. Thus, by elastically deforming, this material allows the driving by friction of the rollers supporting the ribbon.

Advantageously a display device according to the invention will be associated with automated control means, in particular for varying the images.

A mobile unit can contain a motor provided to engage directly on the cassette, which reduces the transmission distance of the movement. It is therefore no longer useful in this case to use a drive belt or a grooved rod in order to transmit the movement of a motor to the ribbon in the cassette, as described in particular with reference to the third embodiment. In another variant, each cell and optionally each cassette can be equipped with its own motor. Thus, the elementary images can be changed simultaneously and independently.

A colour diffusion device, can diffuse the colouring in a way other than by reflection, for example by transparency through the diffusion device.

1. Display method for forming an aggregate image (2) on a variable display device (1) comprising the following stages:
breaking down the aggregate image into several elementary images (6), each corresponding to a cell (4) of a matrix (3) of the display device;
forming series of elementary images on as many ribbons (7) as there are cells in the matrix, each ribbon being associated with a cell and comprising, in the series of elementary images, at least the elementary image corresponding to said cell;
selecting on each ribbon, by making it scroll in the cell to which said ribbon is associated, the elementary image corresponding to said cell.

2. Display method according to claim 1, characterized in that before selecting the elementary image, as element (5) of the display device is selected which comprises the cell of which one wishes to select the corresponding elementary image.

3. Display method according to claim 1, characterized in that before selecting the elementary image, a zone is selected, in particular a line or a column (20), of the display device which comprises the cell of which one wishes to select the corresponding elementary image.

4. Display method according to claim 1, characterized in that the ribbon is rolled up on two spools (9) by each of two of its respective longitudinal ends, the spools being on either side of the cell and that, in order to select an elementary image, the rest of the elementary images can be made to scroll by unrolling one spool and rolling up the other.

5. Display method according to claim 1, characterized in that a ribbon is used which is in the form of a loop.

6. Display method according to claim 5, characterized in that a ribbon is used which is in the form of a Mobius strip.

7. Display method according to claim 1, characterized in that each ribbon is mounted in a removable cassette (15), and in that in order to replace a first ribbon in a cell by a second ribbon, a first cassette containing the first ribbon is replaced in the display device by a second cassette containing the second ribbon.

8. Display device (1) comprising a matrix (3) of cells (4), each intended for the display of an elementary image (6) which is part of the formation of an aggregate image (2), characterized in that the elementary image is supported by a ribbon (7).

9. Display device according to claim 8, characterized in that the ribbon comprises a series of elementary images which can be displayed in the cell equipped with said ribbon, each of said elementary images forming part of the display of one or more aggregate images.

10. Display device according to claim 8, characterized in that the series of elementary images comprises a gradation of the same colour.

11. Display device according to claim 8, characterized in that the series of elementary images comprises several individualized images (6A).

12. Display device according to 11 claim 8, characterized in that the series of elementary images comprises a combination of pixels.

13. Device according to claim 8, characterized in that it comprises a display plate (11) realizing the cell, a visible part of the ribbon being held tight on said plate.

14. Device according to claim 8, characterized in that the ribbon is wound as two spools (9) by each of two of its respective longitudinal ends, the spools being on both sides of the cell and the ribbon being partially visible in the cell.

15. Display device according to claim 14, characterized in that it comprises a mechanism (14, 52) for varying the aggregate image.

16. Device according to claim 15, characterized in that the mechanism for varying the images comprises a mechanism (17, 54), for selecting an elementary image on the ribbon.

17. Device according to claim 16, characterized in that the selection mechanism for an elementary image comprises a drive belt (26) maintained under pressure against the spools so that when said belt is in movement, one of the spools unrolls as much as the other one rolls up.

18. Device according to claim 14, characterized in that each spool rolls up on a roller (8), each roller being equipped with a disk (49) coaxial with the roller, and in that the selection mechanism for an elementary image comprises drive means (61, 99, 112) for driving the disk of one of the rollers in rotation, in particular by friction or by meshing, so that the ribbon rolls up around said one of the rollers by scrolling in the cell.

19. Device according to claim 18, characterized in that the drive means include a wheel driven in rotation by a grooved rod.

20. Device according to claim 18, characterized in that the drive means include a belt (99) mounted between two pulleys (97, 98) of which a first pulley (97) is motorized, the assembly constituted by the belt and the pulleys being able to be swung against the disk (49).

21. Device according to claim 20, characterized in that it comprises a swinging arm which is mobile in rotation about a common axis (X92) with the motorized pulley, the second pulley being mounted on the swinging arm, the swinging arm being able to be swung into a position in which the belt is in contact with the periphery of the disk without slipping.

22. Device according to claim 18, characterized in that the drive means include two rollers (111,112) mounted on an arm (113), so that they are held there at a constant distance from each other and can roll one on the other without slipping, a first roller (111), from the two, being integral in rotation with the shaft (93) of a motor (92) and the second roller (112) being provided to be brought into contact with the disk and to roll without slipping on the periphery of said disk.

23. Device according to claim 17, characterized in that it also comprises a mechanism (16, 53) for the selection of an element (5) of the panel, said element corresponding to a respective cell from which it is sought to select an elementary image, said element comprising the ribbon.

24. Device according to claim 23, characterized in that the selection mechanism for an element comprises a unit (21) which is mobile from one element to the other, said mobile unit comprising a presser wheel (23) which rotates freely in order to roll on a face of the drive belt and to press an opposite face of said drive belt against the spools of the selected element.

25. Device according to claim 24, characterized in that the selection mechanism for an element comprises a displacement belt (19) on which the mobile unit is fixed so that a movement of said displacement belt makes it possible to move said mobile unit from one element to another.

26. Device according to claim 23, characterized in that the selection mechanism (54) of an element comprises a unit (58) which is mobile from one element to the other, said unit being mobile in displacement along an endless screw (57).

27. Device according to claim 26, characterized in that the mobile unit comprises two wheels (61) for driving the disks of the rollers of the same element, said wheels being arranged so that a first can drive the disk of a first roller without the second driving the disk of the second roller.

28. Device according to claim 27, characterized in that the wheels are also arranged so that a minimal displacement of the unit is sufficient so that the first wheel can no longer drive the disk of the first roller and that the second wheel can drive the disk of the second roller.

29. Device according to claim 27, characterized in that each wheel for driving a disk is toothed and in that the drive mechanism also comprises a grooved rod (56) meshing with the toothed wheel in order to drive said toothed wheel in rotation.

30. Device according to claim 8, characterized in that it comprises a brake (28) for immobilizing the ribbon in a chosen position.

31. Device according to claim 8, characterized in that the ribbon comprises an index (12) on its back for identifying an elementary image supported by the front of the ribbon and/or positioning said elementary image in a cell.

32. Device according to claim 31, characterized in that the index is a bar code.

33. Device according to claim 31, characterized in that the index is a reflected binary code.

34. Device according to claim 31, characterized in that the index is written somewhere other than on the back of the image that it allows identification and/or positioning.

35. Device according to claim 31, characterized in that it comprises means for reading (62) the index.

36. Device according to claim 23, characterized in that the selection device of an element comprises a mobile unit which can be moved at the level of at least certain elements, said mobile unit comprising a motor (92) in order to make the ribbon scroll in each of said certain elements.

37. Device according to claim 8, characterized in that the ribbon is mounted on a removable support (15).

38. Device according to claim 8, characterized in that at least one cell is associated with a respective motor in order to make the ribbon scroll in said cell.

39. Device according to claim 8, characterized in that it comprises a cleaning device (107) for the ribbon.

40. Device according to claim 8, characterized in that it comprises between two neighbouring ribbons a diffusion device (107) for colour on at least one of the ribbons.
